(19) United States
(12) Patent Application Publication
(10) Pub. No.: US 2012/0286994 A1
(43) Pub. Date: Nov. 15, 2012

(54) METHOD AND SYSTEM FOR LOCATING INTERFERENCES AFFECTING A SATELLITE-BASED RADIONAVIGATION SIGNAL

(75) Inventors: Franck Letestu, Bourg-De-Peage (FR); Bruno Montagne, Saint-Barthelemy De Vals (FR)

(73) Assignee: THALES, Neuilly-Sur-Seine (FR)

(21) Appl. No.: 13/466,639

(22) Filed: May 8, 2012

(30) Foreign Application Priority Data
May 12, 2011 (FR) 1101443

(51) Int. Cl. G01S 19/21

(52) U.S. Cl. 342/357.59

(57) ABSTRACT

Method for locating sources interfering with a satellite-based radionavigation signal comprising the following steps:
a step of calculating the intercorrelation matrix Rₓₓ of the signals received by the elementary antennas of the said array,
a step of determining a plurality of pointing vectors Sₛ whose components are the antenna gains, in a given direction of pointing \vec{u}ₛ, of each elementary antenna of the said array,
a step of calculating, for each assumption of direction of pointing \vec{u}ₛ, the power of the signal received in this direction by the array of antennas,
a step of searching for maxima among the set of powers P_{sf} calculated and of locating interfering sources in the directions of pointing \vec{u}ₛ corresponding to the said maxima,
an ambiguity resolution step consisting in eliminating, from the search step, the maxima relating to an ambiguity resulting from the geometry of the array.

### FIELD OF THE INVENTION

The present invention relates to the field of the locating of sources interfering with a satellite-based radionavigation signal. More particularly, the invention finds its application in the field of airborne radionavigation systems.

### BACKGROUND OF THE INVENTION

Satellite-based radionavigation systems may be disturbed by interfering sources, intentional or unintentional, for example sources emitting a signal on a frequency close to that of the radionavigation signal or exhibiting harmonics around the frequency of the radionavigation signal.

Consequently, the problem of locating these interfering sources arises so as to be able to deduce therefrom solutions making it possible to improve the reliability of the satellite-based radionavigation system. In particular, the locating of interfering sources pertains to the determination of the number of sources, of their direction of arrival and optionally of their frequency spectrum.

A known solution for locating interfering sources on the basis of the signals received by an array of antennas is based on the MUSIC algorithm, from the English “MUltiple Signal Classification”, the flowchart of which is represented in FIG. 1.

The intercorrelation matrix 101 for the signals received by an array of antennas comprising a plurality of antennas offering spatial diversity is utilized to perform a decomposition 102 into eigenvalues and eigenvectors. The eigenvalues are thereafter ranked 103 in descending order to determine 104 those relating to the signal subspace and those relating to the noise subspace. The two subspaces, signal and noise, are created 105 and a test 106 of the orthogonality of the pointing vector with the noise subspace is carried out. Ultimately, a spike 107 is obtained for the value corresponding to the direction of arrival of the interfering signal.

A drawback of this scheme is that it is difficult to implement on processors with limited resources, in particular for an airborne system, on account of its complexity. Indeed, step 102 of decomposing the intercorrelation matrix into eigenvalues and eigenvectors gives rise to a consequent number of operations.

### SUMMARY OF THE INVENTION

The present invention proposes a solution that is less complex in terms of calculational load and more suited to an implementation on embedded processors for which the resources are limited.

For this purpose, the subject of the invention is a method for locating sources interfering with a satellite-based radionavigation signal received by a receiver system comprising an antenna array comprising at least the following steps:
a step of calculating the intercorrelation matrix Rₓₓ of the signals received by the elementary antennas of the said array,
a step of determining a plurality of pointing vectors Sₛ whose components are the antenna gains, in a given direction of pointing \vec{u}ₛ, of each elementary antenna of the said array,
a step of calculating, for each assumption of direction of pointing \vec{u}ₛ, the power P_{sf} of the signal received in this direction by the array of antennas,
a step of searching for maxima among the set of powers P_{sf} calculated and of locating interfering sources in the directions of pointing \vec{u}ₛ corresponding to the said maxima,
   the said method being characterized in that it furthermore comprises an ambiguity resolution step consisting in eliminating, from the search step, the maxima relating to an ambiguity resulting from the geometry of the array.

In a variant embodiment of the invention, the ambiguity resolution step is carried out by comparison between several successive locations or/and by comparison between several locations carried out by mutually remote items of equipment.

In a variant embodiment of the invention, a step of spatial or spatio-temporal anti-interference processing, implementing at least one filtering with P coefficients, is carried out beforehand on the signals received by the said antenna array.

In a variant embodiment, the method according to the invention furthermore comprises:
a step of determining a plurality of vectors S_{f} of assumptions about the frequency f of the interfering wave, \vec{S}_{f}=[e^{j2πf}^{₁} . . . e^{j2πf}^{ᵢ} . . . e^{j2πf}^{_{P}}], where the frequencies fᵢ, for i varying from 1 to P, are given by the relation

$${f}_{i} = \frac{i \cdot f}{{F}_{e}}$$

with Fₑ the signal sampling frequency,
the said pointing vectors S_{sf} being replaced with their Kronecker product \vec{S}_{sf}=\vec{S}ₛ [symbol] \vec{S}_{f} with the vector S_{f} of frequency assumptions.

In a variant embodiment of the invention, the intercorrelation matrix Rₓₓ is determined with the aid of a decomposition in the form of the product of a triangular matrix φ with the conjugate transpose of the same matrix φ^{H}.

In a variant embodiment of the invention, the calculation of the said powers P_{sf} is performed by solving the following equation (1):

$${P}_{sf} = \frac{1}{{S}_{sf}^{H} \cdot {Rxx}^{- 1} \cdot {S}_{sf}} ,$$

where Rₓₓ⁻¹ is the inverse of the intercorrelation matrix, and S_{sf}^{H} is the conjugate transpose of the vector S_{sf}.

In a variant embodiment of the invention, the said equation (1) is solved at least on the basis of solving the following two equation systems:

$${v}_{i} = \frac{{S}_{sf} ( i ) - {\sum }_{k = 0}^{i - 1} {φ}_{ik} {v}_{k}}{{φ}_{ii}}$$

$${z}_{i} = \frac{{v}_{i} - {\sum }_{k = 0}^{i - 1} {φ}_{ik}^{H} {z}_{k}}{{φ}_{ii}}$$

with S_{sf}(i), the component of index i of the vector S_{sf} and φᵢₖ the component of index (i,k) of the matrix φ, i varying from 0 to N·P−1, where N is the number of elementary antennas of the said array, the power P_{sf} being equal to

$${P}_{sf} = \frac{1}{{S}_{sf}^{H} \cdot z} ,$$

where z is a vector whose components are the variables zᵢ.

In a variant embodiment of the invention, the number of interfering sources is equal to the integer value M which minimizes the following criterion F(M):

$$F ( M ) = K \times ( L - M ) \times log ( \frac{\frac{1}{L - M} \times {\sum }_{i = M + 1}^{L} {λ}_{i}}{{[ {\sum }_{i = M + 1}^{L} {λ}_{i} ]}^{\frac{1}{L - M}}} ) + M \times ( 2 L - M )$$

where L is equal to the number of antennas N that multiplies the number of coefficients P of the filter implemented by the antenna processing step,
K is the number of signal samples over which the intercorrelation matrix Rₓₓ is estimated,
λᵢ are the eigenvalues of the intercorrelation matrix Rₓₓ.

In a variant embodiment of the invention, the eigenvalues λᵢ are replaced, in the criterion F(M), with the diagonal values of the triangular matrix φ.

In a variant embodiment of the invention, the choice of the direction of pointing assumptions is carried out by dichotomy.

In a variant embodiment, the method according to the invention furthermore comprises a step of determining the exact geographical position of the interfering sources by triangulation between the location information provided by a plurality of mutually remote items of equipment.

The subject of the invention is also a satellite-based radio-navigation system comprising at least one antenna array intended to receive a satellite-based radio-navigation signal, an anti-interference processing module suitable for removing the interferences impacting the said signal and a GNSS reception module, characterized in that it furthermore comprises a module for locating interfering sources which is suitable for implementing the locating method according to the invention.

In a variant embodiment of the system according to the invention, the step of calculating the intercorrelation matrix Rₓₓ is executed by the anti-interference processing module which transmits the said matrix Rₓₓ to the locating module.

### BRIEF DESCRIPTION OF THE DRAWINGS

Other characteristics and advantages of the invention will become apparent with the aid of the description which follows, offered in relation to appended drawings which represent:

FIG. 1, a flowchart illustrating the steps of the MUSIC algorithm,

FIG. 2, a flowchart illustrating the steps of implementing the method according to the invention,

FIG. 3, a three-dimensional chart representing the power level as a function of the azimuth and elevation assumptions,

FIG. 4a, a chart representing, in sectional view, the power of the interfering signal as a function of the angle of azimuth as abscissa and of the angle of elevation as ordinate,

FIG. 4b, a chart representing the spectrum of the interfering wave as a function of the angle of azimuth for a fixed angle of elevation,

FIG. 4c, a chart representing the spectrum of the interfering wave as a function of the angle of elevation for a fixed angle of azimuth,

FIGS. 5a, 5b and 5c, three charts equivalent to FIGS. 4a, 4b and 4c in the case where a location ambiguity is detected,

FIG. 6, a schematic of a first variant of the radio-navigation system according to the invention,

FIG. 7, a schematic of a second variant of the radio-navigation system according to the invention.

### MORE DETAILED DESCRIPTION

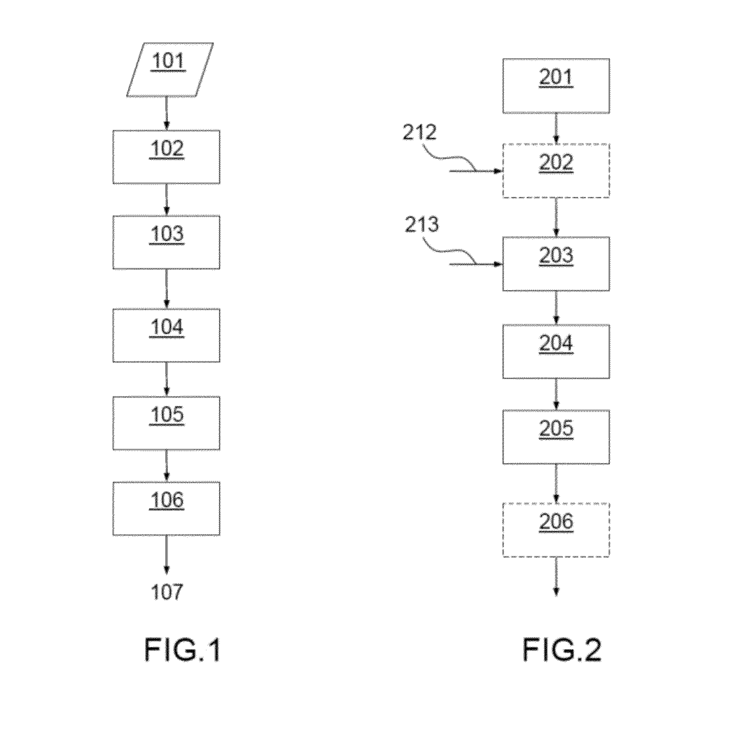

FIG. 2 shows diagrammatically on a flowchart the steps of implementing the method for locating interferences according to the invention. The said method is executed by a satellite-based radionavigation system, operating in reception mode, comprising at least one array of N spatial-diversity antennas which is linked to means for processing the signal received by this array.

In a first step 201, the intercorrelation matrix Rₓₓ of the signals received by the N antennas is determined. One of the possible solutions for determining this matrix while limiting the complexity of the calculations consists in estimating it using a known algorithm of the type QRD-RLS “QR Decomposition Recursive Least Square” which implements a so-called QR decomposition into triangular matrices. The intercorrelation matrix is then obtained through the product of two triangular matrices Rₓₓ=φ·φ^{H}, where ^{H} designates the transpose conjugate operator.

In the case where a step of spatial anti-interference processing SAP “Space Adaptive Processing” or spatio-temporal anti-interference processing STAP “Space Time Adaptive Processing” is applied beforehand to the signals delivered by the antenna array, the intercorrelation matrix Rₓₓ is then of dimension N times P, where P is the number of temporal coefficients of the filter used by the anti-interference processing algorithm.

In order to improve performance and to compensate for the defects of the elementary antennas, the calculation of the intercorrelation matrix Rₓₓ can use the knowledge of the charts of each antenna of the array in terms of phase and gain.

Other schemes or algorithms known to the person skilled in the art may be used to determine the intercorrelation matrix Rₓₓ on the basis of the N signals received.

In a second step 202, the number of interfering sources is determined. Optionally, this item of information may be considered known and forced to a given value 212. In the converse case, it is determined on the basis of searching for a minimum over a given criterion F(M). This criterion takes into account the following information: the number of antennas N, the number of coefficients P of the filter of the anti-interference processing module and the number K of signal samples, for each pathway, on the basis of which information the intercorrelation matrix Rₓₓ is calculated. The criterion F(M) may be formulated with the aid of the following relation:

$$F ( M ) = K \times ( L - M ) \times log ( \frac{\frac{1}{L - M} \times {\sum }_{i = M + 1}^{L} {λ}_{i}}{{[ {\sum }_{i = M + 1}^{L} {λ}_{i} ]}^{\frac{1}{L - M}}} ) + M \times ( 2 L - M ) \qquad ( 1 )$$

L is equal to the product of N times P and λᵢ are the eigenvalues of the intercorrelation matrix Rₓₓ. The number of interfering sources is given by the value of M which minimizes the criterion F. The eigenvalues λᵢ are obtained on the basis of the diagonalization of the matrix Rₓₓ. In the case where the intercorrelation matrix is determined on the basis of a decomposition in the form Rₓₓ=φ·φ^{H}, the eigenvalues λᵢ may be replaced with the values of the diagonal of the triangular matrix φ, thereby exhibiting the advantage of avoiding the expensive calculations to which an eigenvector decomposition of the matrix Rₓₓ gives rise.

In a third step 203, a spatial or spatio-frequency mesh is defined by way of a plurality of pointing vectors so as to determine the spatial and/or frequency search region for the interfering sources. The parameters 213 relating to the region and the search resolution in terms of azimuth, elevation and frequency may be predetermined, for example by a user of the method according to the invention.

In the case of a solely spatial search for the interfering sources, the pointing vector \vec{S}ₛ, for a given direction of pointing s defined by an assumption about the angle of azimuth and angle of elevation, is defined by

$${\vec{S}}_{s} = [ {G}_{{s}_{1}} {e}^{j \frac{2 π ( {\vec{c}}_{1} \cdot {\vec{u}}_{s} )}{λ}} … {G}_{{s}_{N - 1}} {e}^{j \frac{2 π ( {\vec{c}}_{N - 1} \cdot {\vec{u}}_{s} )}{λ}} {G}_{{s}_{N}} {e}^{j \frac{2 π ( {\vec{c}}_{N} \cdot {\vec{u}}_{s} )}{λ}} ] ,$$

with:
\vec{u}ₛ the unit vector of the direction of pointing s,
\vec{c}ᵢ: the vector giving the direction of pointing for antenna i of the array of antennas comprising N elementary antennas,
Gₛ_{ᵢ}: the complex gain of antenna i in the direction of pointing s.
The components

$${G}_{{s}_{N - 1}} {e}^{j \frac{2 π ( {\vec{c}}_{N - 1} \cdot {\vec{u}}_{s} )}{λ}}$$

of the vector \vec{S}ₛ represent the gain of an elementary antenna of the array in the direction of pointing defined by the vector \vec{u}ₛ.

In a variant embodiment of the invention for which a frequency-wise locating of the interfering sources is also implemented, the pointing vector \vec{S}_{sf} is defined as being equal to the Kronecker product of the spatial pointing vector \vec{S}ₛ and a frequency assumption vector \vec{S}_{f}=[e^{j2πf}^{₁} . . . e^{j2πf}^{_{P-1}} e^{j2πf}^{_{P}}], for a frequency f given in the frequency band sought:

\vec{S}_{sf}=Sₛ [symbol] \vec{S}_{f}

The resulting vector \vec{S}_{sf} is of size N·P and is calculated for each spatial and frequency assumption. The frequencies f₁, . . . , fᵢ, . . . , fₚ used to construct the frequency assumption vector S_{f} are linked to the frequency f by the following relation:

$${f}_{i} = \frac{i \cdot f}{{F}_{e}} ,$$

i varying from 1 to P and Fₑ being the signal sampling frequency.

In a fourth step 204, for each spatial or spatio-frequency assumption, the power P_{sf} of the signal received is determined with the aid of the following relation:

$${P}_{sf} = \frac{1}{{S}_{sf}^{H} \cdot {Rxx}^{- 1} \cdot {S}_{sf}} \qquad ( 2 )$$

The power P_{sf} is that of the signal obtained as output from the spatial or spatio-temporal filter used by the algorithm for anti-interference processing under constraint on the one hand of a unit gain in the direction of sighting of the antenna array and on the other hand of rejection of the interfering sources in the other directions.
Equation (2) is obtained on the basis of the following relations, where w is the vector of coefficients of the said filter and x the signal at the input of the filter.

$${P}_{sf} = y \cdot {y}^{H}$$

$$y = {w}^{H} \cdot x$$

$$w = \frac{{R}_{xx}^{- 1} \cdot {S}_{sf}}{{S}_{sf}^{H} \cdot {R}_{xx}^{- 1} \cdot {S}_{sf}}$$

Equation (2) may be advantageously solved by using the following scheme. Initially, equation (2) is separated into two sub-equations:

$$\begin{matrix}{P}_{sf} = \frac{1}{{S}_{sf}^{H} \cdot z} & ( 3 ) \\ {R}_{xx} \cdot z = {S}_{sf} & ( 4 )\end{matrix}$$

Using the QR decomposition of the intercorrelation matrix, Rₓₓ=φ·φ^{H}, the solution of equation (4) reduces to the solution of the following two triangular systems:

$$\{ \begin{matrix}φ \cdot v = {S}_{sf} \\ {φ}^{H} \cdot z = v\end{matrix} \\ or else \\ \begin{matrix}{v}_{i} = \frac{{S}_{sf} ( i ) - {\sum }_{k = 0}^{i - 1} {φ}_{ik} {v}_{k}}{{φ}_{ii}} & ( 5 ) \\ {z}_{i} = \frac{{v}_{i} - {\sum }_{k = 0}^{i - 1} {φ}_{ik}^{H} {z}_{k}}{{φ}_{ii}} & ( 6 )\end{matrix}$$

with i varying from 0 to N×P−1
By solving the systems (5) and (6), an estimate of the power P_{sf} of the signal received is deduced for each spatial assumption s and optionally each frequency assumption f.

Ultimately, a matrix of powers P_{sf} is obtained, containing the set of powers with the various spatial and/or frequency assumptions defined.

In a variant embodiment of the invention, the search parameters 213 may be iteratively updated so as to carry out dichotomy-based location by progressively modifying the spatial and/or frequency search regions, doing so in order to optimize the number of calculations required to arrive at an accurate result. Location can also be performed initially in the spatial domain alone and then in the frequency domain once the direction of arrival of the interfering sources is located.

In a step 205, the matrix of powers P_{sf} is firstly scanned according to the frequency dimension so as to retain only the frequency assumption which corresponds to the power maxima. Subsequently the matrix P_{sf} is scanned, for the frequency assumption retained, according to the spatial dimension and the M local maxima, with M equal to the number of interfering sources, are retained together with the associated pointing directions. For each of the interfering sources thus located, the frequency assumption retained makes it possible to identify their location in the frequency spectrum.

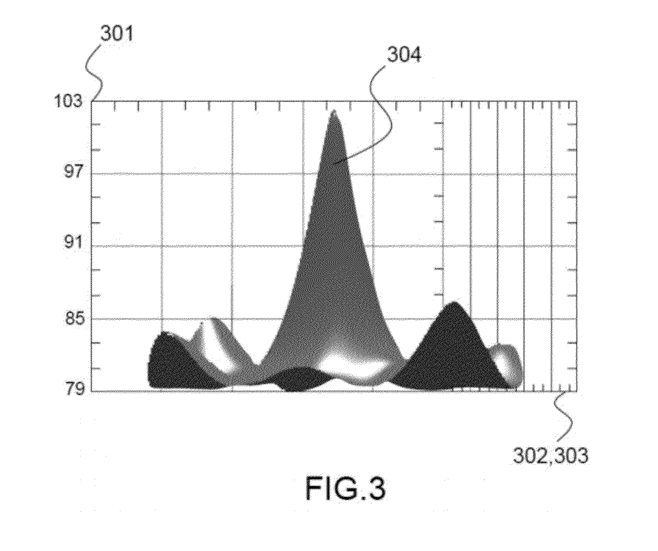

FIG. 3 shows diagrammatically the shape of the matrix of powers P_{sf} represented on a three-dimensional chart. The vertical axis 301 corresponds to the power level, for the frequency assumption for which the power is a maximum, and the abscissa axis 302 and ordinate axis 303 correspond respectively to the azimuth and elevation angle assumptions defining the spatial assumptions. The maximum 304 gives, through its abscissa and ordinate coordinates, the direction of arrival (defined by an angle of azimuth and an angle of elevation). The frequency assumption retained gives an estimation of the frequency of emission of the interfering wave.

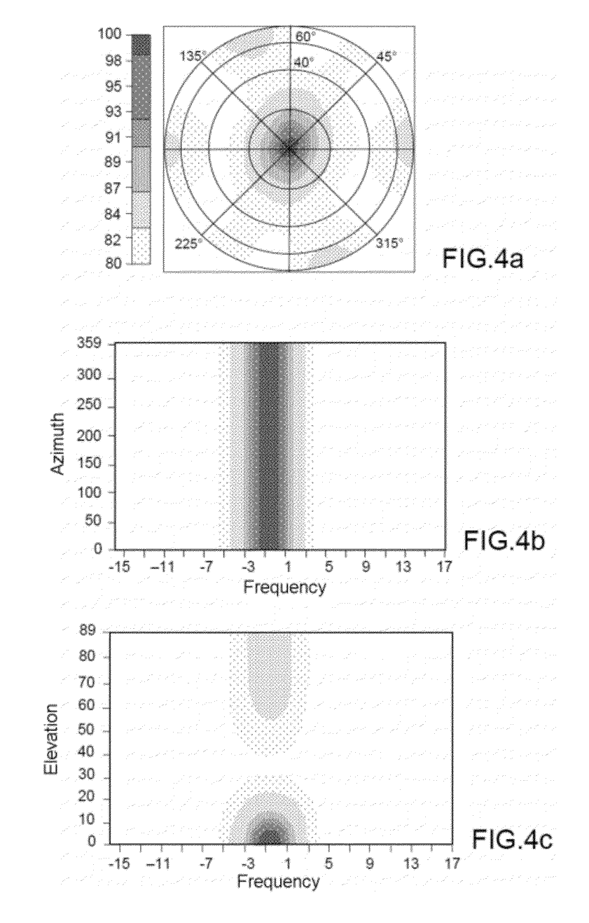

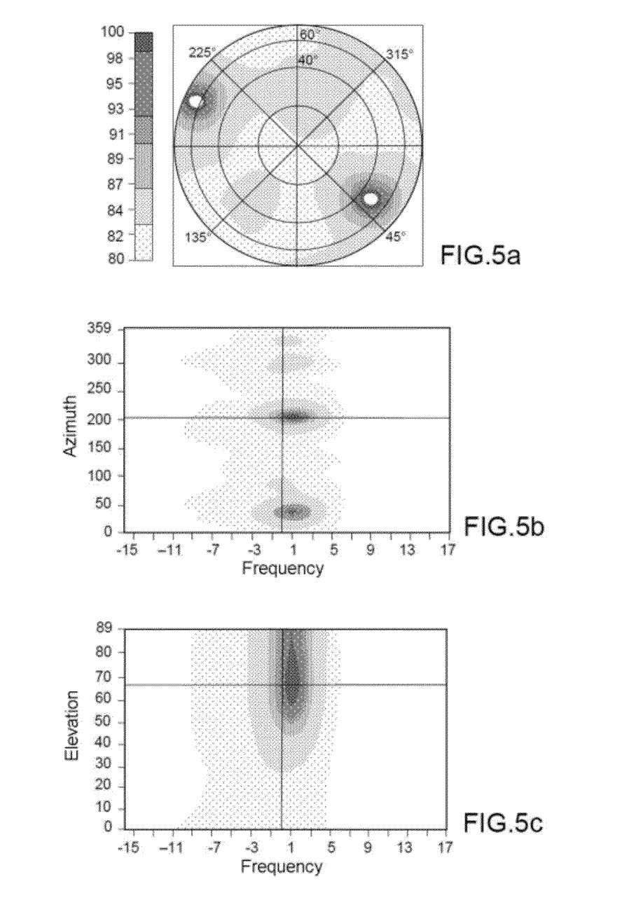

By way of illustration, FIG. 4 shows diagrammatically, on three charts, the results obtained for the location of an interfering source at the zenith, that is to say emitting a wave whose direction of arrival is seen by the array of antennas at a zero angle of azimuth and a zero angle of elevation.

FIG. 4a represents the power of the interfering signal as a function of the angle of azimuth as abscissa and of the angle of elevation as ordinate; it is a sectional view of FIG. 3 for which only the maxima exceeding a given threshold are preserved.

FIG. 4b represents the spectrum of the interfering wave as a function of the angle of azimuth for a fixed angle of elevation.

FIG. 4c represents the spectrum of the interfering wave as a function of the angle of elevation for a fixed angle of azimuth.

As a function of the direction of arrival of the interfering wave and of the geometry of the antenna array, notably of the distance between elementary antennas seen according to the direction of arrival, ambiguities may appear. Such ambiguities appear in the matrix of powers P_{sf} in the form of power maxima of levels close to the levels of the maxima associated with the interfering sources but originating from different directions of arrival.

By way of illustration, FIG. 5 shows diagrammatically, on three charts, the results obtained for the location of an interfering source according to an angle of azimuth of 37° and an angle of elevation of 49° and for which an ambiguity is detected for an angle of azimuth of 204° and an angle of elevation of 66°.

FIG. 5a represents the power of the interfering wave as a function of the angles of azimuth and of elevation.

FIG. 5b represents the spectrum of the interfering wave as a function of the angle of azimuth for a fixed angle of elevation.

FIG. 5c represents the spectrum of the interfering wave as a function of the angle of elevation for a fixed angle of azimuth.

In a step 206, an ambiguity resolution is carried out so as to eliminate the maxima corresponding to ambiguities due to the geometry of the array. As a function of the direction of arrival of the interfering wave seen from each elementary antenna and of the spacing between elementary antennas, it is possible to determine the spatial location, in terms of elevation and azimuth, of an ambiguity with respect to a power spike relating to a genuine interfering source. Several schemes are conceivable for eliminating these ambiguities in the selection of the maxima of the matrix of powers P_{sf}.

A first scheme consists in carrying out a consolidation between several successive locations in the course of time. In the case of a mobile carrier, for example a vehicle, in particular an aircraft, the presence of ambiguities depends on the direction of arrival of the interfering wave with respect to the plane of the array of antennas. Thus, as a function of the direction of the incident wave, the ambiguities appear or disappear whereas the interferences remain present, and it is therefore possible to eliminate the ambiguous spikes by utilizing several successive matrix realizations.

Another scheme consists in consolidating the information arising from several distinct items of equipment implementing the locating method according to the invention. By correlation, it is possible to identify the interfering sources common to the location results provided by the various items of equipment and to eliminate the ambiguities. Indeed, these will be situated in different directions of arrival for each item of equipment since their position is related to the geometry and to the orientation of the array of antennas.

A hybrid scheme can also be envisaged by utilizing both a succession of measurements of power matrices over time and the realizations provided by various mutually remote items of equipment.

In another variant embodiment of the invention, the estimated directions of arrival of the interfering waves provided by several carriers may be aggregated to obtain the exact geographical position of the interfering source or sources by a triangulation scheme associated with an appropriate filtering.

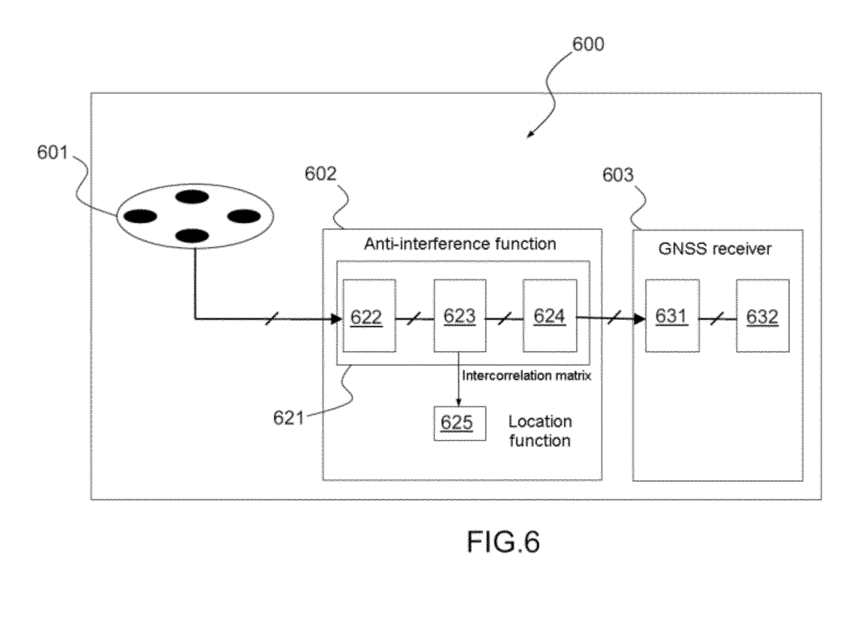

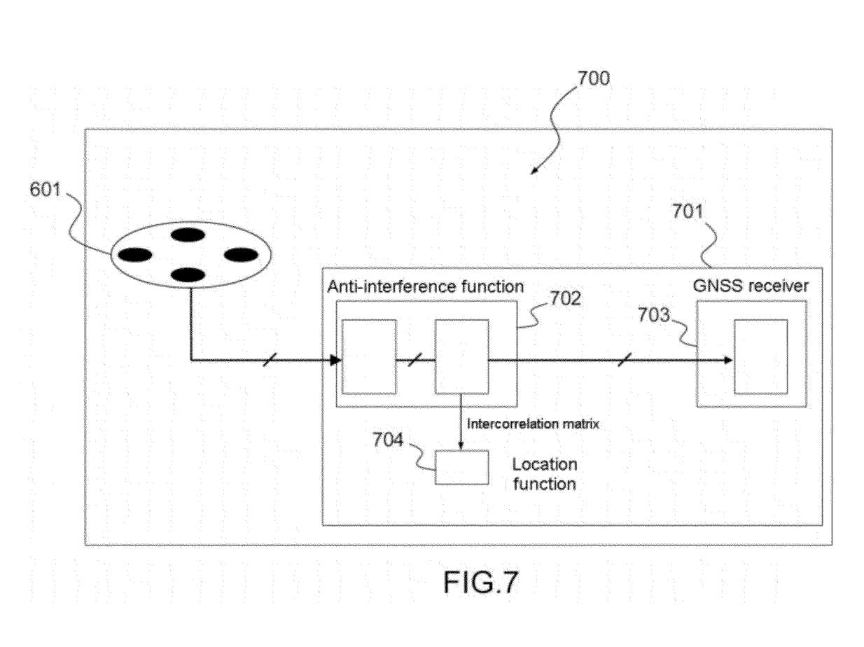

FIGS. 6 and 7 show diagrammatically, on two schematics, two variant embodiments of the system implementing the method according to the invention.

In FIG. 6 is represented a satellite-based radio-navigation system 600 comprising an antenna array 601 intended to receive a radio-navigation signal, a module for processing antennas 602 and a module for receiving radio-navigation signals 603 or GNSS receiver 603. The module for processing antennas 602 comprises at least one anti-interference processing module 621 suitable for carrying out a spatial SAP or spatio-temporal STAP signal processing function so as to eliminate the impact of the interferences in the signal received before the latter is transmitted to the GNSS receiver 603. The anti-interference processing module 621 comprises at least a first card 622 for transposition to low frequency and digitization, a second digital card 623 carrying out the signal processing function suitable for removing the influence of the interferences and a third card 624 for transposition to high frequency. The GNSS receiver 603 itself comprises a first card 631 for transposition to low frequency and digitization and a second digital card 632 suitable for carrying out the navigation processing operations on the basis of the radio-navigation signals received. The anti-interference processing module 621 furthermore comprises a module 625 for locating interfering sources executing the method according to the invention. This module 625 receives, from the digital processing card 623, the intercorrelation matrix for the signals received on the array of antennas 601 and is parametrized by external means providing it with information about the geometry and the characteristics of the array of antennas, notably the charts of antenna gain and phase, as well as the spatial and/or frequency search regions and optionally the number of interfering sources to be located. The interference location module 625 delivers as output the directions of arrival, in terms of azimuth and elevation, of the interfering waves as well as their frequency occupancy and their number when the latter has not been entered as input parameter.

FIG. 7 shows diagrammatically a second variant embodiment of the system 700 according to the invention for which the anti-interference function 702 is directly integrated into the GNSS receiver 701 which furthermore exhibits a GNSS function 703. This variant embodiment makes it possible to dispense with the output transposition card 624 of the antenna processing module and input transposition card 631 of the GNSS receiver. The module 704 for locating interferences, according to the invention, is, as in the system described in FIG. 6, linked to the anti-interference function digital processing card, thereby making it possible, advantageously, to utilize the calculations already carried out to determine the intercorrelation matrix Rₓₓ.

1. Method for locating sources interfering with a satellite-based radionavigation signal received by a receiver system comprising an antenna array, said method comprising the following steps:
a step of calculating the intercorrelation matrix Rₓₓ of the signals received by the elementary antennas of the said array,
a step of determining a plurality of pointing vectors \vec{S}ₛ whose components are the antenna gains, in a given direction of pointing \vec{u}ₛ, of each elementary antenna of the said array,
a step of calculating, for each assumption of direction of pointing \vec{u}ₛ, the power P_{sf} of the signal received in this direction by the array of antennas,
a step of searching for maxima among the set of powers P_{sf} calculated and of locating interfering sources in the directions of pointing \vec{u}ₛ corresponding to the said maxima,
an ambiguity resolution step consisting in eliminating, from the search step, the maxima relating to an ambiguity resulting from the geometry of the array.

2. Method according to claim 1, wherein said ambiguity resolution step is carried out by comparison between several successive locations or/and by comparison between several locations carried out by mutually remote items of equipment.

3. Method according to claim 1, wherein a step of spatial or spatio-temporal anti-interference processing, implementing at least one filtering with P coefficients, is carried out beforehand on the signals received by the said antenna array.

4. Method according to claim 3, furthermore comprising:
a step of determining a plurality of vectors S_{f} of assumptions about the frequency f of the interfering wave, \vec{S}_{f}=[e^{j2πf}^{₁} . . . e^{j2πf}^{ᵢ} . . . e^{j2πf}^{ₚ}], where the frequencies fᵢ, for i varying from 1 to P, are given by the relation
$${f}_{i} = \frac{i \cdot f}{{F}_{e}}$$
with Fₑ the signal sampling frequency,
the said pointing vectors S_{sf} being replaced with their Kronecker product \vec{S}_{sf}=\vec{S}ₛ [symbol] \vec{S}_{f} with the vector S_{f} of frequency assumptions.

5. Method according to claim 4, wherein the intercorrelation matrix Rₓₓ is determined with the aid of a decomposition in the form of the product of a triangular matrix φ with the conjugate transpose of the same matrix φ^{H}.

6. Method according to claim 5, wherein the calculation of the said powers P_{sf} is performed by solving the following equation (1):
$${P}_{sf} = \frac{1}{{S}_{sf}^{H} \cdot {Rxx}^{- 1} \cdot {S}_{sf}} ,$$
where Rₓₓ⁻¹ is the inverse of the intercorrelation matrix, and S_{sf}^{H} is the conjugate transpose of the vector S_{sf}.

7. Method according to claim 6, wherein said equation (1) is solved at least on the basis of solving the following two equation systems:
$${v}_{i} = \frac{{S}_{sf} ( i ) - {\sum }_{k = 0}^{i - 1} {φ}_{ik} {v}_{k}}{{φ}_{ii}}$$
$${z}_{i} = \frac{{v}_{i} - {\sum }_{k = 0}^{i - 1} {φ}_{ik}^{H} {z}_{k}}{{φ}_{ii}}$$
with S_{sf}(i), the component of index i of the vector S_{sf} and φᵢₖ the component of index (i,k) of the matrix φ, i varying from 0 to N·P−1, where N is the number of elementary antennas of the said array, the power P_{sf} being equal to
$${P}_{sf} = \frac{1}{{S}_{sf}^{H} \cdot z} ,$$
where z is a vector whose components are the variables zᵢ.

8. Method according to claim 7, furthermore comprising a step of determining the number of interfering sources, equal to the integer value M which minimizes the following criterion F(M):
$$F ( M ) = K \times ( L - M ) \times log ( \frac{\frac{1}{L - M} \times {\sum }_{i = M + 1}^{L} {λ}_{i}}{{[ {\prod }_{i = M + 1}^{L} {λ}_{i} ]}^{\frac{1}{L - M}}} ) + M \times ( 2 L - M )$$
where L is equal to the number of antennas N that multiplies the number of coefficients P of the filter implemented by the antenna processing step,
K is the number of signal samples over which the intercorrelation matrix Rₓₓ is estimated,
λᵢ are the eigenvalues of the intercorrelation matrix Rₓₓ.

9. Method according to claim 8, wherein the eigenvalues λᵢ are replaced, in the criterion F(M), with the diagonal values of the triangular matrix φ.

10. Method according to claim 1, wherein the choice of the direction of pointing assumptions is carried out by dichotomy.

11. Method according to claim 1, furthermore comprising a step of determining the exact geographical position of the interfering sources by triangulation between the location information provided by a plurality of mutually remote items of equipment.

12. Satellite-based radio-navigation system comprising at least one antenna array intended to receive a satellite-based radio-navigation signal, an anti-interference processing module suitable for removing the interferences impacting the said signal and a GNSS reception module and a module for locating interfering sources which is suitable for implementing a locating method comprising the following steps:
a step of calculating the intercorrelation matrix Rₓₓ of the signals received by the elementary antennas of the said array,
a step of determining a plurality of pointing vectors Sₛ whose components are the antenna gains, in a given direction of pointing \vec{u}ₛ, of each elementary antenna of the said array,
a step of calculating, for each assumption of direction of pointing \vec{u}ₛ, the power P_{sf} of the signal received in this direction by the array of antennas,
a step of searching for maxima among the set of powers P_{sf} calculated and of locating interfering sources in the directions of pointing \vec{u}ₛ corresponding to the said maxima,
an ambiguity resolution step consisting in eliminating, from the search step, the maxima relating to an ambiguity resulting from the geometry of the array.

13. Satellite-based radio-navigation system according to claim 12, wherein the step of calculating the intercorrelation matrix Rₓₓ is executed by the anti-interference processing module which transmits the said matrix Rₓₓ to the locating module.

14. Satellite-based radio-navigation system according to claim 12 wherein said ambiguity resolution step is carried out by comparison between several successive locations or/and by comparison between several locations carried out by mutually remote items of equipment.

15. Satellite-based radio-navigation system according to claim 12 wherein a step of spatial or spatio-temporal anti-interference processing, implementing at least one filtering with P coefficients, is carried out beforehand on the signals received by the said antenna array.

16. Satellite-based radio-navigation system according to claim 15, wherein said module for locating interfering sources is also suitable for implementing the following steps:
a. a step of determining a plurality of vectors S_{f} of assumptions about the frequency f of the interfering wave, \vec{S}_{f}=[e^{j2πf}^{₁} . . . e^{j2πf}^{ᵢ} . . . e^{j2πf}^{ₚ}], where the frequencies fᵢ, for i varying from 1 to P, are given by the relation
$${f}_{i} = \frac{i \cdot f}{{F}_{e}}$$
with Fₑ the signal sampling frequency,
b. the said pointing vectors S_{sf} being replaced with their Kronecker product \vec{S}_{sf}=\vec{S}ₛ [symbol] \vec{S}_{f} with the vector S_{f} of frequency assumptions.

17. Satellite-based radio-navigation system according to claim 16 wherein the intercorrelation matrix Rₓₓ is determined with the aid of a decomposition in the form of the product of a triangular matrix φ with the conjugate transpose of the same matrix φ^{H}.

18. Satellite-based radio-navigation system according to claim 17 wherein the calculation of the said powers P_{sf} is performed by solving the following equation (1):
$${P}_{sf} = \frac{1}{{S}_{sf}^{H} \cdot {Rxx}^{- 1} \cdot {S}_{sf}} ,$$
where Rₓₓ⁻¹ is the inverse of the intercorrelation matrix, and S_{sf}^{H} is the conjugate transpose of the vector S_{sf}.

19. Satellite-based radio-navigation system according to claim 18, wherein said equation (1) is solved at least on the basis of solving the following two equation systems:
$${v}_{i} = \frac{{S}_{sf} ( i ) - {\sum }_{k = 0}^{i - 1} {φ}_{ik} {v}_{k}}{{φ}_{ii}}$$
$${z}_{i} = \frac{{v}_{i} - {\sum }_{k = 0}^{i - 1} {φ}_{ik}^{H} {z}_{k}}{{φ}_{ii}}$$
with S_{sf}(i), the component of index i of the vector S_{sf} and φᵢₖ the component of index (i,k) of the matrix φ, i varying from 0 to N·P−1, where N is the number of elementary antennas of the said array, the power P_{sf} being equal to
$${P}_{sf} = \frac{1}{{S}_{sf}^{H} \cdot z}$$
where z is a vector whose components are the variables zᵢ.

20. Satellite-based radio-navigation system according to claim 19, wherein said module for locating interfering sources is also suitable for implementing a step of determining the number of interfering sources, equal to the integer value M which minimizes the following criterion F(M):
$$F ( M ) = K \times ( L - M ) \times log ( \frac{\frac{1}{L - M} \times {\sum }_{i = M + 1}^{L} {λ}_{i}}{{[ {\prod }_{i = M + 1}^{L} {λ}_{i} ]}^{\frac{1}{L - M}}} ) + M \times ( 2 L - M )$$
where L is equal to the number of antennas N that multiplies the number of coefficients P of the filter implemented by the antenna processing step,
K is the number of signal samples over which the intercorrelation matrix Rₓₓ its estimated,
λᵢ are the eigenvalues of the intercorrelation matrix Rₓₓ.

21. Satellite-based radio-navigation system according to claim 20 wherein the eigenvalues λᵢ are replaced, in the criterion F(M), with the diagonal values of the triangular matrix φ.

22. Satellite-based radio-navigation system according to claim 12, wherein the choice of the direction of pointing assumptions is carried out by dichotomy.

23. Satellite-based radio-navigation system according to claim 12, furthermore comprising a step of determining the exact geographical position of the interfering sources by triangulation between the location information provided by a plurality of mutually remote items of equipment.
